(19) United States
(12) Patent Application Publication
(10) Pub. No.: US 2024/0428706 A1
(43) Pub. Date: Dec. 26, 2024

(54) WEARABLE SPINAL TRAINING DEVICE

(71) Applicant: EDWARD VIA COLLEGE OF OSTEOPATHIC MEDICINE, Blacksburg, VA (US)

(72) Inventors: David Kashmer, Blacksburg, VA (US); Kaitlin Dinsmoore, Blacksburg, VA (US); Tom Lindsey, Blacksburg, VA (US)

(21) Appl. No.: 18/750,731

(22) Filed: Jun. 21, 2024

Related U.S. Application Data
(60) Provisional application No. 63/522,242, filed on Jun. 21, 2023.

(51) Int. Cl. G09B 23/28

(52) U.S. Cl. CPC G09B 23/285

(57) ABSTRACT

Described and demonstrated herein are embodiments of a wearable training device that is capable of realistic simulation of a plurality of spinal column regions for training of multiple procedures. In a simulated training procedure, a user may pierce the outer skin of the training device with a syringe needle. The user may direct the syringe needle to a tube within the vertebrae that simulates a spinal cord. The user may pierce the tube and use the syringe to extract the fluid from the tube and/or inject fluid into the tube and remove the syringe from the training device.

### CROSS-REFERENCE TO RELATED APPLICATIONS

This application claims the benefit of and priority to U.S. Provisional Patent Application No. 63/522,242, filed on Jun. 21, 2023, the contents of which is incorporated by reference herein in its entirety.

### TECHNICAL FIELD

The subject matter disclosed herein is generally directed to training devices for medical treatments, simulations, and other purposes.

### BACKGROUND

Healthcare students and providers need proper training tools to be able to render effective medical care to patients. Proper medical training for critical scenarios involving spinal conditions are essential to prevent potential accidents or mistakes.

Whether for simple or complex medical procedures, the use of procedural skills trainers and simulators is a key part of this education process. To optimize the fidelity, procedural skills trainers need to be flexible in their capabilities depending on the scenario and simulation. With this in mind, there exists a need for improved skills trainers.

Citation or identification of any document in this application is not an admission that such a document is available as prior art to the present invention.

### SUMMARY

In certain example embodiments, described herein is a training device configured to be wearable during use, comprising: an external portion comprising an outer simulated skin layer, wherein the simulated skin layer; and a body configured to contact the torso of a wearer when worn by the wearer and is further configured to support an internal portion; an internal portion comprising a tube of simulation fluid and simulated vertebrae; and one or more fastening members coupled to the body, wherein the one or more fastening members are configured to secure the device to the torso of a wearer when worn during use.

In some example embodiments, the simulated skin layer simulates human epidermal, dermal, subcutaneous, muscle layers, or combinations thereof. In some example embodiments, the tube is configured to simulate a spinal cord. In some example embodiments, the fastening member is a strap that encircles a torso of the wearer. In some example embodiments, the wearer is a person or a manikin.

In some example embodiments, the body is constructed of a rigid material that is resistant to punctures by a needle. In some example embodiments, the tube is constructed of a flexible plastic. In some example embodiments, the simulated skin is composed of a silicone rubber embedded fabric.

In some example embodiments, the one or more fastening members are fastened to the wearer with one or more of a clip, buckle, or hook and loop portion. In some example embodiments, the simulated skin self-repairs when a needled is retracted after piercing the simulated skin. In some example embodiments, the tube has a connector on at least one terminal end to connect to a syringe. In some example embodiments, the connector is a Luer lock.

In some example embodiments, the one or more fastening members connect to the body of the device via one or more slots in the body. In some example embodiments, the simulation fluid is distilled water. In some example embodiments, the simulation fluid simulates spinal fluid. In some example embodiments, described herein are methods of using the device described and demonstrated herein, comprising filling the tube with the simulation fluid; securing the device to a torso of the wearer with the one or more fastening members; and performing a simulated medical procedure on the device by: inserting a syringe needle through the simulated skin and into the tube; extracting the simulation fluid from the tube with the syringe; and retracting the syringe needle from the device.

The method of filling the tube with the simulation fluid may include filling a second syringe with simulation fluid; affixing the second syringe to the connector of the tube; depressing a plunger of the second syringe to inject the simulation fluid into the tube; and removing the second syringe from the connector. The method may include removing entrained air from the simulation fluid. The method may include positioning the syringe needle between at least two vertebrae to access the tube. The method may include filling a reservoir in the tube with simulation fluid to provide additional simulation fluid for extraction.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present invention will be obtained by reference to the following detailed description that sets forth illustrative embodiments, in which the principles of the invention may be utilized, and the accompanying drawings of which:

FIG. 1 is an image of a wearable training device strapped to a spinal region of a person.

FIG. 2 is an image of a wearable training device with simulated vertebrae.

FIG. 3 is an image of a wearable training device with a strap affixed.

FIG. 4 is an image of an underside of a wearable training device with simulation fluid affixed.

FIG. 5 is an image of a wearable training device with the simulation fluid affixed to the underside of the wearable training device.

FIG. 6 is an image of a syringe needle extracting simulated fluid from the wearable training device.

FIG. 7 is an image of a syringe injecting simulated fluid into the tube of the wearable training device.

FIG. 8 is a block flow diagram of a method to fill the wearable training device.

FIG. 9 is a block flow diagram of a method to use the wearable training device.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further aspect includes from the one particular value and/or to the other particular value. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

### General Definitions

Unless defined otherwise, technical and scientific terms used herein have the same meaning as commonly understood by one of ordinary skill in the art to which this disclosure pertains.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosed invention. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

The recitation of numerical ranges by endpoints includes all numbers and fractions subsumed within the respective ranges, as well as the recited endpoints.

As used herein, a “biological sample” may contain whole cells and/or live cells and/or cell debris. The biological sample may contain (or be derived from) a “bodily fluid”. The present invention encompasses embodiments wherein the bodily fluid is selected from amniotic fluid, aqueous humour, vitreous humour, bile, blood serum, breast milk, cerebrospinal fluid, cerumen (earwax), chyle, chyme, endolymph, perilymph, exudates, feces, female ejaculate, gastric acid, gastric juice, lymph, mucus (including nasal drainage and phlegm), pericardial fluid, peritoneal fluid, pleural fluid, pus, rheum, saliva, sebum (skin oil), semen, sputum, synovial fluid, sweat, tears, urine, vaginal secretion, vomit and mixtures of one or more thereof. Biological samples include cell cultures, bodily fluids, cell cultures from bodily fluids. Bodily fluids may be obtained from a mammal organism, for example by puncture, or other collecting or sampling procedures.

The terms “subject,” “individual,” and “patient” are used interchangeably herein to refer to a vertebrate, preferably a mammal, more preferably a human. Mammals include, but are not limited to, murines, simians, humans, farm animals, sport animals, and pets.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present invention. Thus, appearances of the phrases “in one embodiment,” “in an embodiment,” or “an example embodiment” in various places throughout this specification are not necessarily all referring to the same embodiment. Furthermore, the particular features, structures or characteristics may be combined in any suitable manner, as would be apparent to a person skilled in the art from this disclosure, in one or more embodiments. Furthermore, while some embodiments described herein include some, but not other, features included in other embodiments, combinations of features of different embodiments are meant to be within the scope of the invention. For example, in the appended claims, any of the claimed embodiments can be used in any combination.

All publications, published patent documents, and patent applications cited herein are hereby incorporated by reference to the same extent as though each individual publication, published patent document, or patent application was specifically and individually indicated as being incorporated by reference.

### Overview

Healthcare students and providers need proper training tools to be able to render effective medical responses to various spinal conditions. Proper medical training for these critical scenarios helps provide the greatest good for the greatest number of situations and ultimately save lives. Whether it be simple or complex medical procedures, the use of procedural skills trainers and simulators is a key part of this education process. To optimize the fidelity, procedural skills trainers need to be flexible in their capabilities depending on the scenario and simulation. However, current devices are specialized for different purposes and thus fail to have sufficient flexibility to be applicable for multiple training, simulation, and other purposes.

With some of the deficiencies of current devices in mind, described herein is a simulation training device that can be used, in some embodiments, as a trainer for extracting bodily fluids from a spinal region. More specifically, the present description encompasses a hybrid medical trainer that can fully and completely function as both a traditional tabletop procedural skills trainer or worn on a person or manikin to offer a more realistic training experience.

To optimize the learning experience, the device realistically simulates one or more regions of a vertebrae, spinal columns, and the spinal cord, which are described below. The training device can have simulated skin on an outer surface, simulated vertebrae, a tube to simulate a spinal cord, and fluids to simulate spinal fluid or other fluids. Furthermore, the device can be moulageable (i.e., capable of accepting moulage makeup) and repairable, allowing rapid device preparations, adjustments, repairs, and replacements for better usability and durability. Lastly, the device can be lightweight and safe, while allowing multiple medical procedures to be completed while keeping the wearer safe from needle sticks, lacerations, punctures, or other sharps injuries.

Described herein are several embodiments of a training device that can be capable of realistic simulation of a plurality of spinal column regions for training of multiple procedures. For example, in some embodiments, in a simulation, a user may pierce the outer skin of the training device with a syringe. The user may then direct the syringe to the tube within the vertebrae. The user may pierce the tube and use the syringe to extract the fluid from the tube and remove the syringe from the training device.

The training device is also scalable in its depiction of the procedures. The configuration of the training device can be such that the training device can be worn by a person for training and simulation or be used as a stand-alone device. In some embodiments, the training device may be robust enough for a plurality of medical procedures to be completed while keeping an optional wearer safe from tools used during the procedure simulations, such as from needle sticks, lacerations, punctures, or other potential sharps injuries.

Other compositions, compounds, methods, features, and advantages of the present disclosure will be or become apparent to one having ordinary skill in the art upon examination of the following drawings, detailed description, and examples. It is intended that all such additional compositions, compounds, methods, features, and advantages be included within this description, and be within the scope of the present disclosure.

### Wearable Training Device

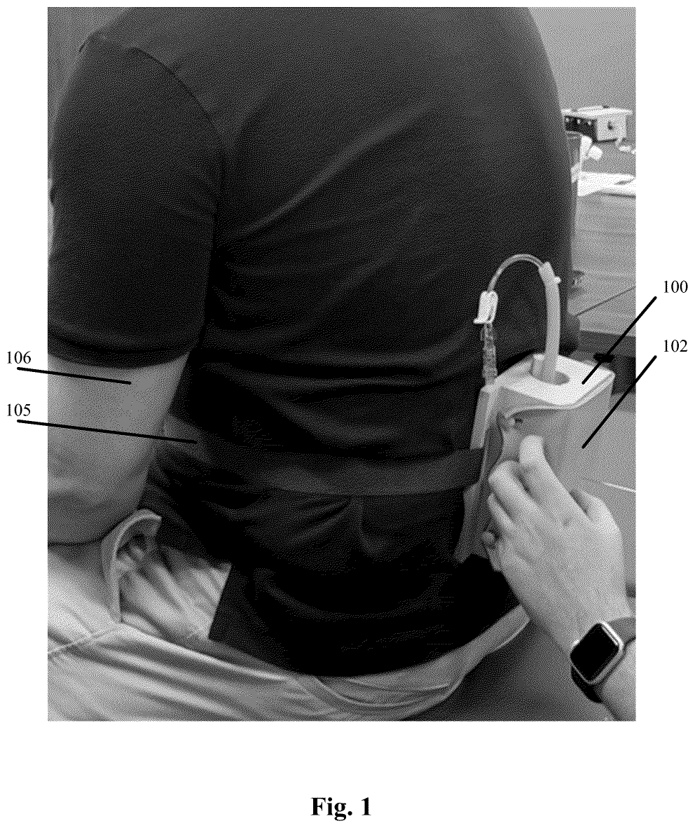

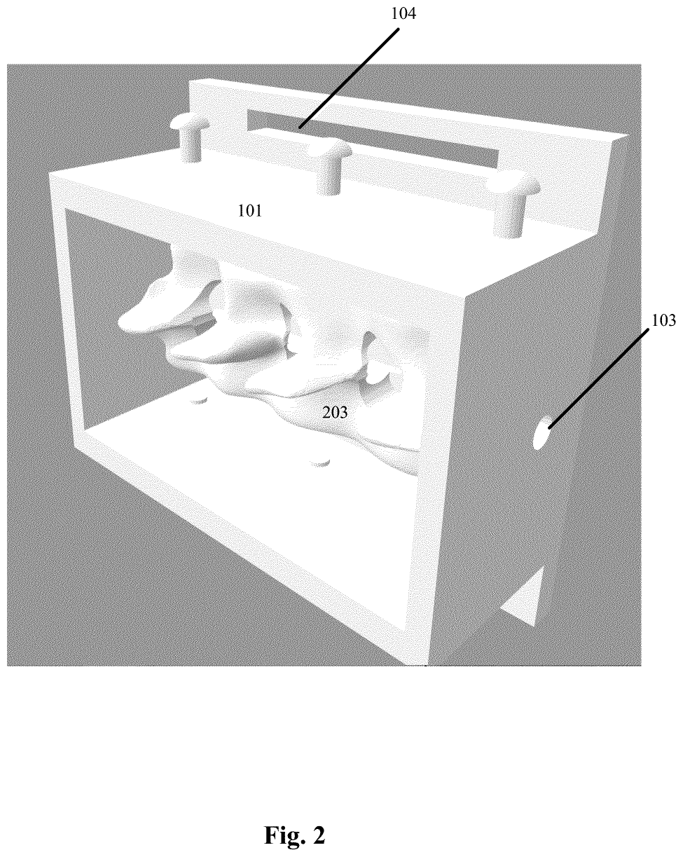

Discussion of the several embodiments of the wearable training device begins with FIG. 1, which is an image of an embodiment wearable training device 100 during a use and strapped to a spinal region of a wearer 106. In such embodiments, the device 100 is affixed to the wearer 106 via a fastener 105. The fastener 105 can be any suitable means, including but not limited to, a strap, vest, raiment, shirt, belt, suspenders, snaps, hook and loop portion, and/or the like that can affix the device 100 to the wearer 106. The fastener 105 is affixed to the device 100 via slots depicted in FIG. 2. In some embodiments, the fastener 105 is a strap, belt, cinch, or other band device that can encircle the wearer 106 and be secured with a clip, buckle, hook and loop portion, knot, or any other suitable mechanism to secure the strap around the wearer 106. The wearer 106 can be a person, an animal, a manikin, or other live or inanimate body. In some embodiments, the device 100 may be affixed to a wearer 106 with any other suitable type of mechanism. In some embodiments, the device 100 may be affixed to an elastic strap that is placed around the wearer 106. In some embodiments, the device 100 may be affixed to a shirt, vest, raiment, or other garment that is worn by the wearer 106. In some embodiments device 100 may be affixed directly to the skin of the wearer 106 with an adhesive. Skin-safe adhesives are generally known in the art.

The device 100 can be affixed to any suitable region of the wearer 106. In FIG. 1, the device 100 is affixed to a lower lumbar region of the person. In other examples, the device 100 may be affixed to a neck region, upper lumbar region, thoracic lumbar region, cervical lumbar region, or any other suitable region of the wearer 106.

In some embodiments, the device 100 includes an external simulated skin 102 that can be composed of one or more sumulated skin layers. The external simulated skin 102 can be positioned on the device such that it is the layer closest to the user and farthest away from a wearer 106 or an object that the device 100 is placed or otherwise affixed to. In some embodiments, the external simulated skin 102 of the device 100 may be composed of one or more layers that include an outer simulated skin layer and one or more additional layers that are positioned between the outer simulated skin layer and the device 100. The one or more layers simulated skin layers can form a laminate. In some embodiments, each of the one or more simulated skin layers are independently composed of a suitable material such that the look, texture, feel, flexibility, punctureablitiy, etc. mimic the skin. Exemplary suitable materials include, but are not limited to, silicone rubber embedded fabric or other type of fabric, plastic, silicone, rubber, or other substance that simulates human skin. The external simulated skin 102 may be suitable to receive a syringe needle or other extraction tool that pierces the simulated skin 102. In other words, the external simulated skin 102 can be puncturable, such as by a needle or other tool that would be capable of piercing the skin of a subject. The external simulated skin 102 may self-repair the puncture created by the syringe needle. The external simulated skin 102 may be replaced as needed if the punctures cause damage to the external simulated skin 102. In some embodiments, the external simulated skin 102 is partially or wholly self-healing. In other words, the materials of a self-healing external simulated skin layer partially or wholly fill back in where it was punctured or pierced.

The device may have one or more additional layers or objects under the external simulated skin 102. The one or more layers or objects may simulate muscle, fat, bone, organs, or other materials. Each layer may be composed of one or more material selected from the group of: a closed-cell foam, a plastic, a resin, a silicone rubber, a composite material, or other suitable materials. Suitable plastics for use in one or more components of the device as described herein, can include but are not limited to, polyester plastics and high-density polyethylene plastics. Suitable resins for use in the device as described herein, can include but are not limited to high density polyethylene resins and polyester resins. Suitable composite materials for use in one or more components of the device as described herein, can include but are not limited to polyethylene and polyester plastics that can be encapsulated in closed-cell foam and silicone rubber. As used herein a “composite material” refers to materials are a combination of two or more materials with different physical and/or chemical properties such that the composite material does not have the exact same characteristics (physical, chemical, optical, and/or electrical, etc.) as any of the individual materials forming the composite material.

In some embodiments, the thickness of the external simulated skin 102 can range from about 5 mm to 2 cm or more. In some embodiments, the thickness of the external portion can range from about 5 mm, 6, 7, 8, 9, 10, 11, 12, 13, 14, 15, 16, 17, 18, 19, to 20 mm or more. In some embodiments, each of the one or more skin layers of the external simulated skin 102 each can have a thickness ranging from about 0.01 mm to 20 mm or more.

In some embodiments, the external simulated skin 102 is stretchable, pliable, cuttable, repairable, self-healing capable of accepting multiple forms of moulage makeup in order to simulate anatomic variation, capable of accepting different blunt and penetrating injuries, and any combination thereof.

In some embodiments, the external simulated skin 102 and the optional one or more additional layers of the of the external portion of the device simulate human epidermal, dermal, subcutaneous, muscle layers, or combinations thereof.

The device 100 includes a body 101 that supports the external simulated skin 102. The body 101 includes the slots 104 that secure the device 100 to the fastener 105. The body 101 may be manufactured from any structural material, such as stainless steel, aluminum, plastic, fiberglass, or any other suitable material. The portion of the body 101 that is between the tube and vertebrae is constructed of a material that is rigid enough to prevent a needle on a syringe from penetrating the body 101. That is, the body 101 protects a wearer from being injured by a needle or other sharp object.

The device 100 and portions thereof can be made using any suitable fabrication technique, including but not limited to hand or machine building and assembly, computer-aided design, computer numerical control and cutting, casting, injection molding, machine stamping, or additive manufacturing (also known as 3D-printing).

In some embodiments, the wearable training device 100 is configured to be used with an augmented realty or virtual reality training system and/or simulation. In such embodiments, the wearable training device 100 includes one or more barcodes, QR codes, Near Field Communication (NFC) tag or are otherwise NFC-enabled, or other suitable code or tag.

In some embodiments, the simulated vertebrae 203 and any other simulated tissue included in the wearable trainer is configured to simulate an average healthy adult (fully grown) patient. In some embodiments, the simulated vertebrae 203 and any other simulated tissue included in the wearable trainer is configured to simulate an average healthy senior patient. In some embodiments, the simulated vertebrae 203 and any other simulated tissue included in the wearable trainer is configured to simulate an average healthy adolescent patient. In some embodiments, the simulated vertebrae 203 and any other simulated tissue included in the wearable trainer is configured to simulate an average healthy child patient. In some embodiments, the simulated vertebrae 203 and any other simulated tissue included in the wearable trainer is configured to simulate an average healthy infant patient. In some embodiments, the simulated vertebrae 203 and any other simulated tissue included in the wearable trainer is configured to simulate an average male patient. In some embodiments, the simulated vertebrae 203 and any other simulated tissue included in the wearable trainer is configured to simulate an average female patient.

In some embodiments, the simulated vertebrae 203 and any other simulated tissue included in the wearable training device 100 is configured to simulate an abnormal or diseased state, such as a spinal column disease or condition (including, but not limited to, scoliosis, stenosis, lordosis, kyphosis, arthritis, herniated discs, abscesses, vertebral fractures, degenerative disc disease, hematomas, and/or the like). In some embodiments, the simulated vertebrae 203 and any other simulated tissue included in the wearable training device 100 is configured to simulate an abnormal or diseased state, such as a spinal column disease or condition in an adult. In some embodiments, the simulated vertebrae 203 and any other simulated tissue included in the wearable training device 100 is configured to simulate an abnormal or diseased state, such as a spinal column disease or condition in an adolescent. In some embodiments, the simulated vertebrae 203 and any other simulated tissue included in the wearable trainer is configured to simulate an abnormal or diseased state, such as a spinal column disease or condition in a child. In some embodiments, the simulated vertebrae 203 and any other simulated tissue included in the wearable training device 100 is configured to simulate an abnormal or diseased state, such as a spinal column disease or condition in an infant. In some embodiments, the simulated vertebrae 203 and any other simulated tissue included in the wearable training device 100 is configured to simulate an abnormal or diseased state, such as a spinal column disease or condition in a senior adult. In some embodiments, the simulated vertebrae 203 and any other simulated tissue included in the wearable training device 100 is configured to simulate an abnormal or diseased state, such as a spinal column disease or condition in a female. In some embodiments, the simulated vertebrae 203 and any other simulated tissue included in the wearable training device 100 is configured to simulate an abnormal or diseased state, such as a spinal column disease or condition in a male.

Discussion of the wearable training device 100 continues with FIG. 2 which shows an image of a wearable training device 100 with simulated vertebrae 203. The device 100 is illustrated with a body 101 encompassing the simulated vertebrae 203 inside an interior of the body 101. The simulated vertebrae 203 may be any suitable vertebral bones or structures in a body. For example, the simulated vertebrae 203 may be simulated lower lumbar vertebrae or upper lumbar vertebrae. The simulated vertebrae 203 may be constructed of plastic, fiberglass, rubber, silicone, foam, any combination thereof, or any other suitable material(s) to simulate vertebrae. In some embodiments, the simulated vertebrae 203 has a channel 103 within that supports a tube (not pictured in FIG. 2). The channel 103 has an orifice at either end of a body 101 to allow a tube to enter one end of the body 101, proceed through the simulated vertebrae 203, and exit an opposing end of the body 101. The body 101 is illustrated with the slots 104 for receiving a fastener 105 or other mechanism for securing the device 100 to the wearer 106.

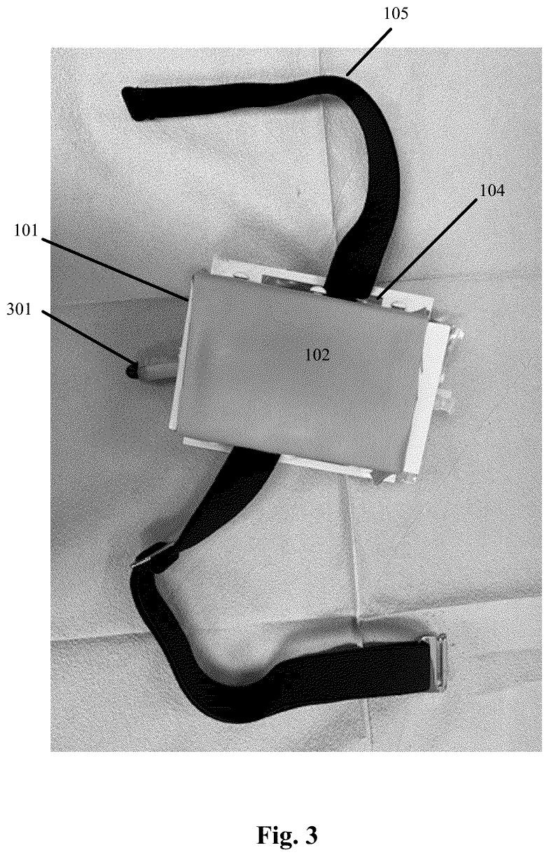

Further embodiments of the wearable training device 100 can be understood in connection with FIG. 3, which is an image of a wearable training device 100 with a fastener 105 affixed. The device 100 is pictured with an external simulated skin 102 affixed to the body 101. The external simulated skin 102 is substantially parallel with a surface of the wearer 106 to which the device 100 is affixed. In some embodiments, the device 100 is picoted with the slots or other openings 104 for receiving the fastener 105. In some embodiments, the device 100 contains snaps, hook or loop closure etc. for affixing a fastener 105 to the device 100.

The device 100 is illustrated with a tube 301. The tube 301 enters the channel 103 and protrudes from either end of the body 101. The tube 301 may be constructed of any suitable grade of plastic or other material to simulate a spinal column or other bodily structure. In an example, the tube is comprised of a plastic, such as PTFE, PVC, polyethylene, polyurethane, or any other suitable material. The outer diameter of the tube 301 can range from about 5 mm to 20 mm, such as 5, 6, 7, 8, 9. 10, 11, 12, 13, 14, 15, 16, 17, 18, 19, or 20 mm. The tube wall may have a thickness ranging between 1 mm and 5 mm, such as 1, 2, 3, 4, or 5 mm. The tube 301 can be flexible to allow movement within the vertebrae 203. The tube 301 may be self-healing to allow multiple punctures with needles to be performed before replacement is required.

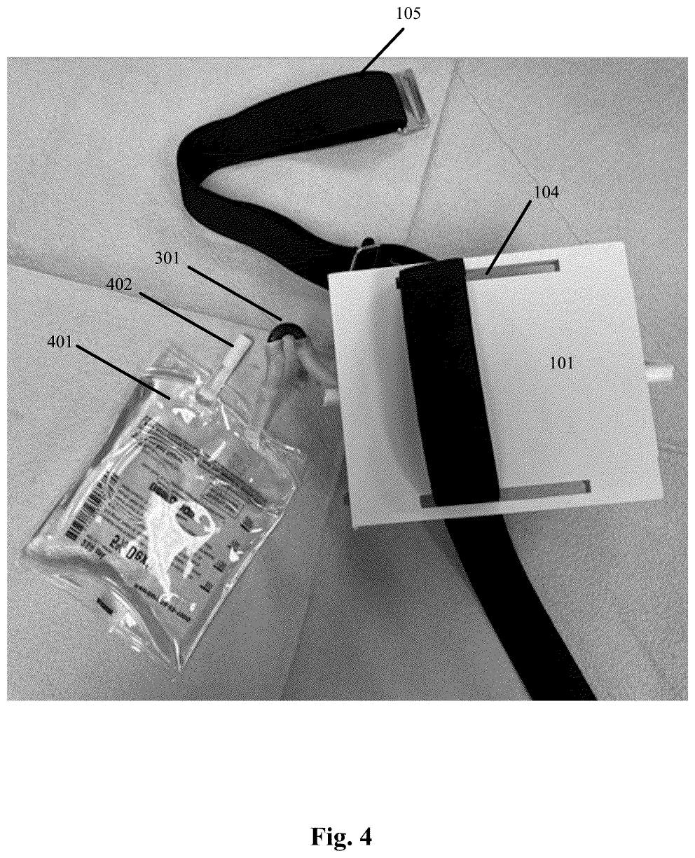

In some embodiments, the tube may be coupled to a fluid reservoir (e.g., 401, FIG. 4) and be in fluid communication with the fluid reservoir. The tube and/or fluid reservoir can be configured to receive or contain any type of suitable simulation fluid. In an example, the simulation fluid is simulating spinal fluid, blood, or any other suitable fluid. The simulation fluid may be distilled water, glycol, or any other suitable fluid. The simulation fluid may be a combination of fluids to simulate different types of bodily fluids. In an example, a higher viscosity fluid may be used or a lower viscosity. In an example, different colors of simulation fluid may be used to allow for different techniques to be practiced.

Discussion of the wearable training device 100 continues with FIG. 4, which is an image of an underside of a wearable training device 100 with simulation fluid affixed. Illustrated are the device 100 with the body 101, the fastener 105, the slots 104, and the tube 301. The reservoir 401 is illustrated in line with the tube 301. The reservoir 401 holds the reservoir of simulation fluid that may be provided to the tube 301. The tube 301 or the reservoir 401 may have a connector 402, such as a valve, gate, or other type of mechanism to attach to a syringe for providing or removing simulation fluid. In an example, the connector 402 is a Luer lock.

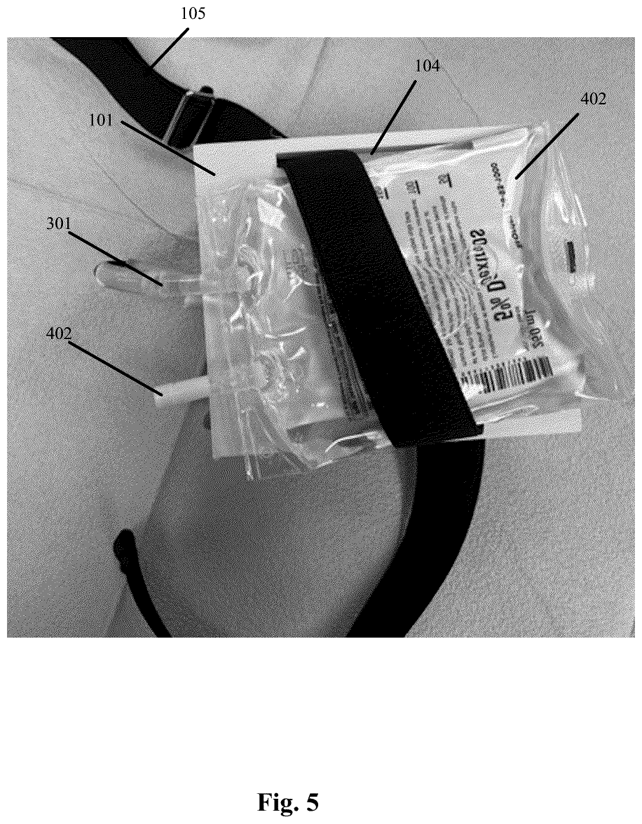

Discussion of the wearable training device 100 continues with FIG. 5, which is an image of a wearable training device 100 with the simulation fluid reservoir 401 affixed to the underside of the wearable training device 100. The device 100 is illustrated with a body 101, slots 104, and the fastener 105. In some embodiments the reservoir 401 is inserted between the body 101 and the fastener 105. The reservoir 401 is thus secured when in use by a wearer. In some embodiments, the reservoir 401 can be positions such that it is against the skin of the wearer 106. This placement allows for a softer point of contact between the body 101 and the wearer 106. The connector 402 is accessible for filling or emptying of the tube 301. In other embodiments, the reservoir 401 is placed at a distance from the device 100. In some embodiments, the reservoir may be in a pocket of a garment worn by the user, such as vest, shirt, jacket, or other garment to which the device 100 is affixed or not affixed. In other embodiments, the reservoir 401 is placed at a distance from the device 100, such as under a table or other object on which the device is placed.

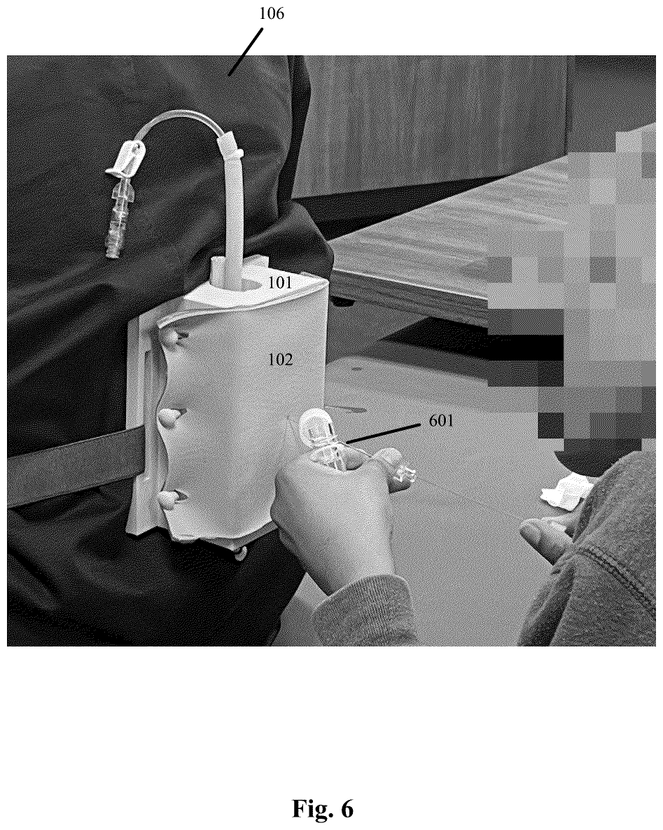

Discussion of the wearable training device 100 continues with FIG. 6, is an image during use of the device that shows a user using a syringe needle 601 extracting simulated fluid from the wearable training device 100. In the illustration, the training device 100 is affixed to a wearer 106. A user is inserting the needle 601 of a syringe through the simulated skin 102 of the training device 100. The needle 601 may pierce the tube 301 inside the training device 100 to extract fluid within. This can simulate collection of spinal fluid, such as a lumbar puncture. It will be appreciated that the device may also be used for delivery of fluids to the spinal column of a patient.

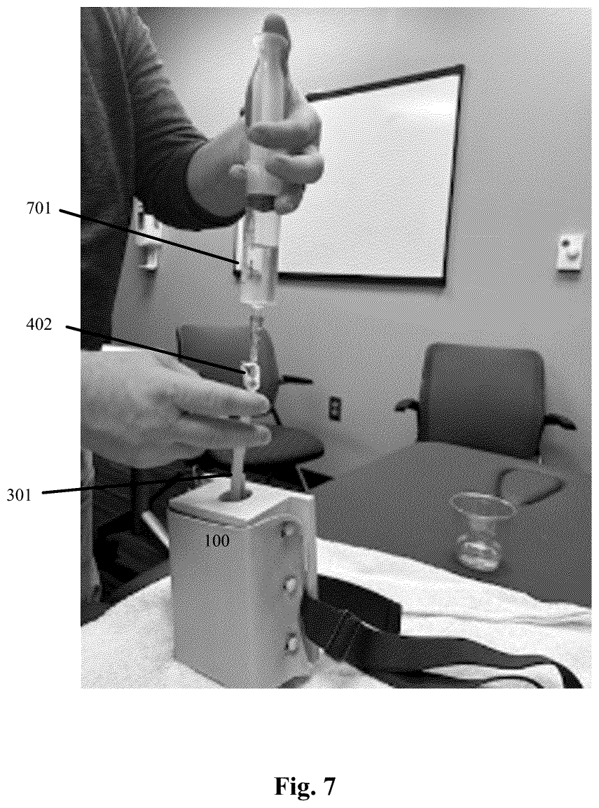

Discussion of the wearable training device 100 continues with FIG. 7, which is an image of a syringe 701 injecting simulated fluid into the tube 301 of the wearable training device 100. The syringe 701 is affixed to the connector 402 that is located at the terminal end of the tube 301. The user is depressing the syringe 701 to force the simulation fluid into the tube 301. This readies the device for use. In other embodiments, the tube 301 can be connected to one or more other fluid pumps, reservoirs and/or the like so as to manage the pressure or other characteristics of the simulated fluid in the tube 301. In some embodiments, such pumps, reservoirs, etc. are also wearable and affixed or otherwise integrated with the wearable training device. In other embodiments, the pumps and/or reservoirs are coupled to the wearable training device but are not an integrated part of device such that they are capable of being worn by a wearer. In such embodiments, the pumps, reservoirs can be configured to or are attached to an object, such as a chair, bed, procedure table, fluid stand, etc. that can be proximate to the wearer during use of the wearable training device.

### Methods of Using the Wearable Training Device

Also described herein are methods of using the wearable device described in greater detail herein. An advantage of the configuration of the device is that it is strong enough to be used as a stand-alone device when placed on a surface with the external portion facing out and away from the surface it is placed on but is also appropriately shaped and/or soft enough such that it is comfortable enough for a human to wear through a medical or other procedure being performed on the device. Any suitable spinal procedure can be performed using the wearable training device, including but not limited to any procedure that requires an injection into the spine, spinal column, vertebral joints, and/or a procedure that requires collection of spinal fluid. In some embodiments, the wearable training device is used in concert with an augmented or virtual reality. In such embodiments, a user would scan a code, e.g., barcode, QR code, NFC, etc. present on the wearable training device during use.

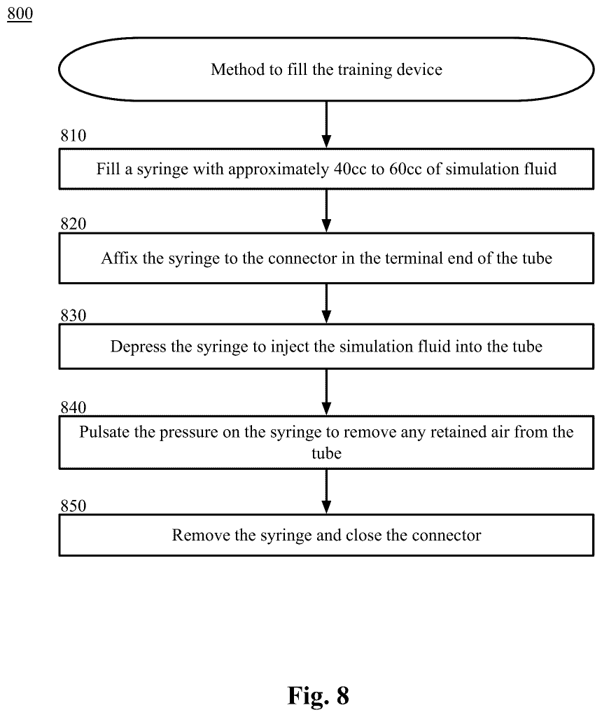

Discussion turns to FIG. 8, which is a block flow diagram of a method 800 to fill the wearable training device. In block 810, a user fills a syringe 701 with a suitable amount of simulation fluid. In some embodiments, the amount of simulation fluid is approximately 40cc to 60cc of simulation fluid. It will be appreciated that the amount of simulation fluid will depend on the procedure being simulated, the patient being simulated, etc. The amount of simulation fluid needed is based on the length and inner diameter of the tube 301.

In block 820, the user affixes the syringe 701 to the connector 402 in the terminal end of the tube 301. The connector 402 as described may be a Luer lock or other similar valve or connector.

In block 830, the user depresses the syringe 701 to inject the simulation fluid into the tube 301. The simulation is forced into the tube 301 by the pressure created in the syringe 701. The tube 301 is filled with the simulation fluid.

In block 840, the user pulsates the pressure on the syringe 701 to remove any retained air from the tube 301. For example, the user may withdraw a plunger on the syringe 701 then depress the plunger multiple times to cycle the pressure in the tube 301. The air bubbles are forced out of the tube 301.

In block 850, the user removes the syringe 701 and closes the connector 402. The tube 301 is now filled with simulation fluid and is ready for use.

It will be appreciated that in some embodiments, as previously described, the wearable training device can be coupled to a pump or other simulation fluid control system that can take the place of the syringe just described. In these embodiments, the pumps, or other flow control devices can be operated so as to manage the fluid pressure of the simulation fluid.

In any instance, the pressure of the simulation fluid can be adjusted to mimic different conditions.

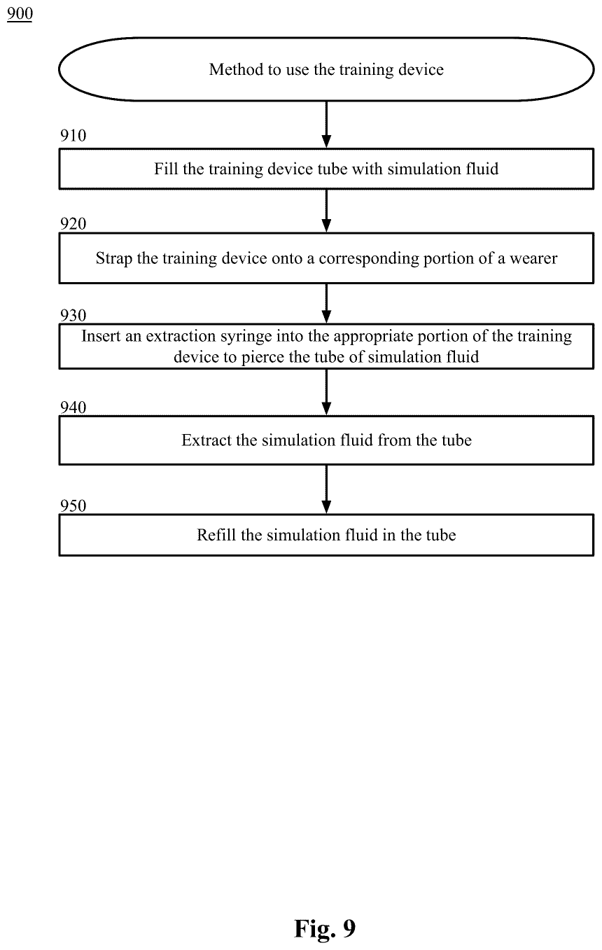

Discussion of methods of using the device 100 continues with FIG. 9, which is a block flow diagram of an exemplary method 900 to use the wearable training device 100.

In block 910, the user fills the tube 301 with simulation fluid, as described in greater detail in the method 800 of FIG. 8 and elsewhere herein.

In block 920, the user straps the device 100 onto a corresponding portion of a wearer 106. For example, if the device 100 is configured with vertebrae 203 and tube 301 that mimic the lower lumbar region of a spinal column, then the device 100 may be strapped onto the lower lumbar region of a wearer 106, such as a person or a manikin.

In block 930, the user inserts an extraction syringe into the appropriate portion of the device 100 to pierce the tube 301 containing simulation fluid. The syringe may be any syringe with a needle 601 attached to withdraw fluids. The needle 601 may pierce the external simulated skin 102 of the device 100 and be positioned against the outer surface of the tube 301. The needle 601 may then be injected into the tube 301 such that the end of the needle 601 is within the simulation fluid inside the tube 301.

In block 940, the user extracts the simulation fluid from the tube 301. For example, the user withdraws a plunger on the syringe to create a vacuum inside the syringe. The vacuum causes the simulation fluid in the tube 301 to enter the body of the syringe. The syringe may be extracted from the tube 301 and back out through the external simulated skin 102.

In block 950, the user may refill the simulation fluid in the tube 301. The tube may seal the puncture hole in the tube wall. Since fluid was removed, more simulation fluid may be added to replace the removed fluid. The fluid may be added in a similar manner as the method 800 in FIG. 8.

FIG. 9 describes a fluid extraction training procedure using the wearable training device described herein. As described elsewhere herein, the wearable training devices can be used for training procedures that include an injection of a fluid or other material into the spinal column. Just as described in FIG. 9, the user can insert an injection syringe into the device 100 to pierce the tube 301 containing simulation fluid. The injection syringe may be any syringe having a reservoir to contain a fluid to be delivered and a needle attached that can pierce the simulated skin and tube so as to facilitate delivery of the fluid to be delivered. The needle may pierce the external simulated skin 102 of the device 100 and be positioned against the outer surface of the tube 301. The needle 601 may be further inserted so as to pierce the tube 301 such that the end of the needle 601 is within the simulation fluid inside the tube 301. The user can then inject a fluid into the tube by, e.g., depressing a plunger on the syringe so as to deliver the fluid within in the syringe to the tube 301.

What is claimed is:

1. A training device configured to be wearable during use, comprising:
an external portion comprising an external simulated skin, wherein the external simulated skin; and
a body configured to contact a torso of a wearer when worn by the wearer and is further configured to support an internal portion;
an internal portion comprising a tube of simulation fluid and simulated vertebrae; and one or more fastening members coupled to the body, wherein the one or more fastening members are configured to secure the device to the torso of a wearer when worn during use.

2. The device of claim 1, wherein the external simulated skin simulates human epidermal, dermal, subcutaneous, muscle layers, or combinations thereof.

3. The device of claim 1, wherein the tube is configured to simulate a spinal cord.

4. The device of claim 1, wherein the fastening member is a strap that encircles a torso of the wearer.

5. The device of claim 1, wherein the wearer is a person or a manikin.

6. The device of claim 1, wherein the body is constructed of a rigid material that is resistant to punctures or piercings.

7. The device of claim 1, wherein the tube is constructed of a flexible plastic.

8. The device of claim 1, wherein the external simulated skin comprises or consists of a silicone rubber embedded fabric.

9. The device of claim 1, wherein the one or more fastening members are fastened to the wearer with one or more of a clip, buckle, or hook and loop portion.

10. The device of any claim 1, wherein the external simulated skin self-repairs after piercing the external simulated skin.

11. The device of claim 1, wherein the tube has a connector on at least one terminal end to connect to a syringe.

12. The device of claim 11, wherein the connector is a Luer lock.

13. The device of claim 1, wherein the one or more fastening members connect to the body of the device via one or more slots or openings in the body.

14. The device of claim 1, wherein the simulation fluid is distilled water.

15. The device of claim 1, wherein the simulation fluid simulates spinal fluid.

16. A method of using the device of claim 1, the method comprising:
filling the tube with the simulation fluid;
securing the device to a torso of the wearer with the one or more fastening members; and
performing a simulated medical procedure on the device by:
inserting a needle through the external simulated skin and into the tube, wherein the needle is coupled to a syringe;
extracting the simulation fluid from the tube and/or injecting a fluid into the tube via the syringe; and
retracting the needle from the device.

17. The method of claim 16, wherein filling the tube with the simulation fluid comprises:
filling a second syringe with simulation fluid;
affixing the second syringe to the connector of the tube;
depressing a plunger of the second syringe to inject the simulation fluid into the tube; and
removing the second syringe from the connector.

18. The method of claim 17, further comprising removing entrained air from the simulation fluid.

19. The method of claim 16, further comprising positioning the syringe needle between at least two vertebrae to access the tube.

20. The method of claim 16, further comprising filling a reservoir in the tube with simulation fluid to provide additional simulation fluid for extraction.
